(19) United States
(12) Patent Application Publication
(10) Pub. No.: US 2018/0056575 A1
(43) Pub. Date: Mar. 1, 2018

(54) Treatment Fluid Guidance in a Film Stretching Plant

(71) Applicant: Lindauer DORNIER GmbH, Lindau (DE)

(72) Inventors: Karsten RESCH, Weissensberg (DE); Dieter WOHLGENANNT, Bregenz (AT); Wolfgang KLIER, Lindau (DE)

(73) Assignee: Lindauer DORNIER GmbH, Lindau (DE)

(21) Appl. No.: 15/557,664

(22) PCT Filed: Mar. 2, 2016
(86) PCT No.: PCT/EP2016/054355

§ 371 Date: Sep. 12, 2017

(30) Foreign Application Priority Data
Mar. 18, 2015 (DE) 10 2015 204 871.3

(51) Int. Cl. B29C 55/16; B29C 71/02

(52) U.S. Cl. CPC B29C 55/165; B29C 71/02

(57) ABSTRACT

A film stretching plant is described, which comprises a furnace (3), which consists of several treatment zones (1, 1a) which each respectively comprise a ventilation unit (2). The film (4) is suppliable to the furnace (3) through a film inlet region (5) and is thermally treatable zone-wise in the treatment zones (1, 1a). The treatment fluid (6) supplied to the film stretching plant flows over the film (4) on its upper surface and its lower surface in the treatment zones (1, 1a). In the film stretching plant according to the invention, the treatment fluid (6) is circulatable in the respective treatment zone (1, a) by its associated respective ventilation unit (2) for the thermal treatment of the film (4), and a portion (6a) of the treatment fluid (6) is conveyed from the respective treatment zone (1) to the process-technically following treatment zone (1a). This portion (6a) of the treatment fluid (6) that is conveyed into the following treatment zone (1a) is conveyed decoupled from the passage region of the film (4) in the treatment zones (1, 1a), wherein the respective treatment zones (1, 1a) are equipped with a heat exchanger, by means of which the portion (6a) of the treatment fluid (6) conveyed to it is adaptable to the temperature that is process-technically required in this treatment zone for the thermal treatment of the film (4).

The invention relates to a film stretching plant with a furnace or oven consisting of several treatment zones that each respectively comprise a ventilation unit, according to the preamble of claim 1.

Such film stretching plants, which are also referred to as film stretching machines, serve to stretch plastic films generally biaxially after a flowable plastic has been extruded onto a cooling roll, cooled there, and solidified or hardened to the extent so that a film arises that is to be stretched in the plant, which film is guided through treatment stations and a plurality of treatment zones that form a so-called furnace or oven. In the successive treatment zones, a treatment fluid is heated up to defined temperatures and subsequently, for treatment of the film, is brought into contact therewith on the upper surface and lower surface thereof. In that regard, the individual treatment zones are designed or configured so that they can be brought to the temperature necessary for the treatment of the film in the respective treatment zones, independently of one another, by means of corresponding heat exchangers, depending on the requirements and depending on the plastic type of the film that is to be treated. Such a film stretching machine is described in DE 36 16 955 C2.

Aside from required longitudinal stretching regions and transverse stretching regions of the film stretching plant, the air guidance or conveyance in the central part of the film stretching plant, the furnace, plays a central role for the energetic optimization of such plants as well as for the quality of the film being produced.

In order to achieve the most uniform possible treatment fluid distribution as well as heat treatment in the respective treatment zones, numerous nozzle systems for the treatment fluid in the respective treatment zones have been developed. Thus, in EP 2 123 427 A1 it has been suggested to arrange the outlet nozzles for the treatment fluid in a zig-zag-shape in several rows perpendicular to the motion direction of the film through the plant, in order to be able to achieve a most uniform possible heat transmission rate in the width direction of the film. A total optimization of the treatment fluid guidance or conveyance through the entire plant is, however, not addressed in this prior art.

The quality of the produced film is also decisively dependent on the air guidance or conveyance. If, for example, the air flows through the various different treatment zones with the film while forming laminar flows along the furnace interior through the furnace, then this has a relatively small uniformity of the temperature as a result. If this problem is to be avoided, then it has been suggested in known plants, to always supply or add the quantity of treatment fluid that is being removed. This, however, leads to the result that large quantities of treatment fluid must be moved and heated up, which is disadvantageous for reasons of energy efficiency.

A further problem that is significant in connection with the attainment of a high quality film, is the removal or sharp reduction of the evaporated or volatalized film content materials, which are called contaminants in the following. These are, for example, oligomers, waxes and oils or caprolactam or others, depending on the film material. In that regard it involves film components that are released during the stretching and during the heating, without involving abrasive wear in that regard. The contaminants arise in that polymers are generally not pure, but rather also contain short-chained components, which evaporate or volatilize during the heating, and which, if applicable during the cooling of the film, before it exits the furnace, again re-sublimate or condense and are deposited on the film, which contributes to a worsening of the quality. The quantity, type and intensity of contaminants deposited on the surface of films also depends on the plastic of which the film consists.

In any event the type of the guidance or conveyance of the treatment fluid and the temperature in the respective treatment zones, in connection with the utilized plastic for the film to be produced, plays a decisive role, if it is intended to remove the contaminants out of the treatment fluid before they have the opportunity to become deposited on the surface of the film in order to thereby worsen the film quality.

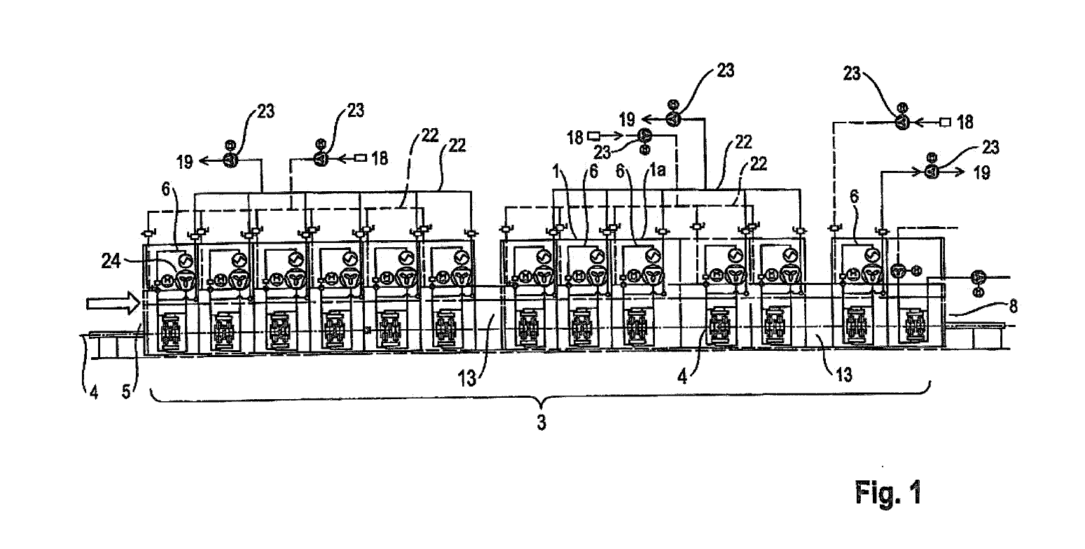

Moreover, the type of the guidance or conveyance of the treatment fluid has a considerable influence on the quantity of installed or constructed pipelines and therewith also the costs of such a plant. A known film stretching plant (see FIG. 1) constructed and distributed by the applicant does already achieve a relatively high uniformity of the temperature in the respective treatment zones. This can only be achieved, however, at the expense of a relatively high energy consumption and a great effort or expense of the installed or constructed pipes.

One possibility to reduce this great pipeline effort or expense consists in passing the treatment fluid through the treatment zones along the film. While this in turn reduces the energy consumption, it however strengthens the longitudinal flow through the plant which is detrimental to a high uniformity of the temperature.

Therefore, the object underlying the invention consists in providing a film stretching plant while avoiding the disadvantages of such plants in the prior art, which minimizes the need of fresh treatment fluid to be supplied to the film and the energy supply needed therefor, reduces or avoids a disadvantageous influence of contaminants on the quality of the film, keeps low any temperature fluctuations of the treatment fluid in the respective treatment zones, which temperature fluctuations are unintended for ensuring a high quality of the film, and in which the quantity of externally installed or constructed pipes for the treatment fluid is reduced.

This object is achieved with a film stretching plant with the features according to claim 1. Suitable or purposeful further developments are defined in the dependent claims.

According to the invention, the film stretching plant comprises an oven or furnace that consists of several treatment zones, with which respectively one ventilation unit is connected. This ventilation unit can be arranged next to the treatment zones, but is, however, preferably arranged on the respective treatment zone and is also referred to as a so-called penthouse. The film can be supplied to the furnace through a film inlet region. The individual treatment zones are autonomous or independent with regard to the treatment of the film, so that the film can be thermally treated in a zone-wise manner, and particularly in such a manner so that the treatment fluid supplied to the film stretching plant flows over the film on the upper side as well as the lower side thereof in the treatment zones. This flowing around the film in the passage region of the film through the treatment zone is now realized in such a manner so that a laminar flow in the direction of the passage of the film through the respective treatment zone is minimized.

According to the invention, the treatment fluid is circulatable in the respective treatment zone by its respective allocated ventilation unit for thermal treatment of the film, whereby a portion of the treatment fluid is guided or conveyed from the respective treatment zone to the process-technically following or subsequent treatment zone. In principle, however, 100% of the treatment fluid is circulated in the respective treatment zone. Thereby each treatment zone is individually adjustable or regulatable to the required thermal treatment object or function of the film in this treatment zone. The portion of the treatment fluid that is guided or conveyed from the treatment zone into the subsequent treatment zone is guided or conveyed through the treatment zones decoupled from the passages region of the film. This means that, in the region in which the film passes through the respective treatment zone, the treatment fluid does not get out of the respective treatment zone into the process-technically following or subsequent zone. Rather, the further passage of the predetermined portion of the treatment fluid occurs at a different location in the treatment zone, in any event at least largely not in the passage region of the film.

Further according to the invention, the respective treatment zone is equipped with a heat exchanger, which is preferably integrated into the ventilation unit, and by means of which the portion of the treatment fluid that has been circulated and supplied here can be adapted or matched to the temperature that is process-technically required for the thermal treatment of the film in this treatment zone. Thus, if the quantity of treatment fluid present in a treatment zone is circulated for the thermal treatment of the film, then this takes place at the temperature level that is required for the thermal treatment of the film in the treatment zone. If now a portion of the treatment fluid is transferred out of a treatment zone into the process-technically following or subsequent treatment zone, then this portion initially generally has a temperature that can differ from the temperature that is required for the thermal treatment of the film in the subsequent zone.

Within a treatment zone, the entire treatment fluid circulating therein experiences an addition of heat via a heat exchanger. In that regard, so much heat is supplied to the partial flow of treatment fluid that is supplied from the adjacent treatment zone, so that the temperature difference is compensated or evened-out. So much heat is supplied to the entire treatment fluid circulating in the treatment zone so that the heat loss as a result of radiation and convection from components of the treatment zone and as a result of the heating of the film is compensated or evened-out. Because adjacent treatment zones in many cases comprise a temperature difference that is process-technically relatively small, for this reason the quantity of heat energy that must be supplied to the partial flow is usually smaller than if the partial flow would have to be supplied from outside. Overall therefore, already for this reason, a saving of energy while maintaining thermal treatment conditions for the film is ensured, which additionally ensure a high quality of the film.

According to a further development of the invention, treatment fluid can be supplied to the furnace in the film inlet region and in the film outlet region in such a manner so that, with respect to its flow direction through the furnace and the film motion direction, it flows from the film inlet region through the furnace in a unidirectional or parallel flow and flows from the film inlet region in a counterflow. This is process-technically especially advantageous because the treatment temperature increases step-wise or continuously beginning from the film inlet region up to a region of treatment zones with the highest temperatures for the thermal treatment, whereas from there to the film outlet region of the furnace the temperature of the treatment fluid decreases.

Through the guidance or conveyance of the partial flow of treatment fluid (6a) from treatment zones with process-technically lower temperatures to treatment zones with process-technically higher temperatures, the condensation or re-sublimation of contaminants is avoided. For this reason, the above described formation of a unidirectional or parallel flow region and a counterflow region is effective or sensible in many cases.

Preferably the treatment fluid is air. Preferably the portion of the treatment fluid conveyed to the respective treatment zone as well as the heat exchanger allocated to the respective ventilation unit are independent of one another or are regulatable in coordination to one another in such a manner so that a defined temperature profile or temperature level can be adjustedly set on the thermally treated film in the respective treatment zone. In that regard, the defined temperature profile can be a temperature profile which reflects a variability of the temperature over time within the treatment zone as well as a temperature profile that develops locally over the individual ventilation units so that ultimately a defined temperature profile is present in the entire furnace, to which the film being treated in the furnace is subjected. A significant advantage of the regulatability of the quantity of treatment fluid, which is guided or conveyed from one treatment zone to the process-technically following or subsequent treatment zone, and the regulatability of the heat exchanger consists in a heat treatment of the film that is on the one hand energy efficient yet also optimal with regard to the thermal treatment of the film.

Preferably a removal location for the removal of treatment fluid is provided process-technically after the film inlet region. By providing a removal location for treatment fluid, through which preferably the quantity of treatment fluid that is removable through this removal location is regulatable, the flexibility of the film stretching plant is further increased with respect to the treatment fluid guidance or conveyance through the plant. Furthermore, by the regulation of the quantity of the removal of treatment fluid, the elimination of possibly arising contaminants can be achieved in the sense of a reduction thereof in the furnace along the further passage of the film through the furnace.

Preferably, the removal of treatment fluid through the removal location takes place at at least one treatment zone, or the removal takes place through respectively one removal location at two treatment zones arranged adjacent one another, in which treatment temperatures exist, which are higher than those in the remaining treatment zones. This means that a removal of treatment fluid is preferably carried out from the treatment zones with the process-technically highest temperatures. In these treatment zones, the quantity of evaporated or volatilized contaminants is the highest. If treatment fluid is removed out of these regions of the furnace, the reduction thereof in the direction of the passage or through-flow of the film through the furnace can be influenced most strongly in absolute quantities. A corresponding cleaning of the contaminants out of the removed treatment fluid can be achieved via additional plants or equipments, so that energy-economically a treatment fluid from which a certain quantity of contaminants has been removed or from which essentially all contaminants have been removed can again be guided or conveyed back into the process.

Preferably the film stretching plant additionally comprises a catalyzer or catalytic converter, through which the removed treatment fluid can be guided or conveyed, which is arranged externally from the treatment zones, and which catalytically treats the removed treatment fluid. In principle it is possible to provide several catalyzers so that such a catalyzer can be allocated at least to several treatment zones in the region of the highest process temperatures. It is, however, also possible, and this is the preferred variant, that a central catalyzer is present, which is impinged upon with treatment fluid out of the treatment zone with the process-technically highest temperature.

Preferably, a filter for filtering the catalytically treated treatment fluid is allocated to the catalyzer, after the catalyzer in the through flow direction. On the one hand, a large portion of the contaminants are catalytically combusted in the catalyzer, so that by providing a filter, the residues arising thereby can be filtered out and a relatively clean treatment fluid can again be supplied to the furnace or to the respective treatment zone. Thereby, besides the cleaning or removal of contaminants, on the other hand there also arises an energy efficient reuse of the treatment fluid with respect to the entire treatment process in the furnace.

Preferably, a heat recovery device is additionally arranged after the catalyzer or after the filter in the throughflow direction, wherein the recovered heat energy of the heat recovery device can again be supplied to the furnace, and/or from which the treatment fluid can again be supplied to selected treatment zones depending on the temperature profile or temperature level to be realized in the respective treatment zone. Thereby, overall an optimization of the treatment fluid with respect to the energetic cost is achieved, in order to adjust this treatment fluid to the temperature profile that is to be achieved in the furnace or in the respective treatment zones. Preferably the heat recovery device is a heat exchanger. The regulatability of the heat supply that is desired for the process or the plant is achieved in the heat exchanger of the treatment zone. The recovered energy is preferably supplied to the respective treatment zone. Further preferably, the removal of treatment fluid is realized out of the treatment zones that are arranged at the end of the unidirectional or parallel flow region and at the end of the counterflow region. Thereby, the removal takes place in the region at which the unidirectional or parallel flow region and the counterflow region are contiguous or bounding on one another. Thereby a relatively exact adjusted setting of the treatment fluid guidance or conveyance in the respective regions and treatment zones can be further improved.

Additionally, further preferably a bridging device for conveying or transferring treatment fluid over a treatment-free neutral zone to the process-technically following or subsequent treatment zone is arranged. This bridging device can receive heat energy supplied from the heat recovery device, and particularly in such an amount that the fed-back treatment fluid directly does justice to the treatment-technical influencing according to the treatment parameters that are to be achieved there. This means that the treatment fluid, already before entering into the subsequent treatment zone, is adapted or adjustedly set in a targeted manner to the process-technical requirements or conditions that are to be realized in this treatment zone, with respect to its parameters that are necessary for that. Preferably the bridging devices are regulatable with respect to the volume flow of the treatment fluid. Thereby it is possible to regulate the quantity of treatment fluid that is bridging over a neutral zone to the next zone that is process-technically located after the neutral zone, so that a high flexibility can be achieved in the treatment fluid conveyance and the attainment of a defined temperature profile or temperature level that is optimal for the treatment.

According to a further example embodiment, the furnace consists of numerous treatment zones in the form of inlet zone, stretching zones, fixing zones and outlet zones, wherein additionally heating zones, cooling zones and neutral zones can be provided. The number and the type of the various different types of treatment zones is oriented on the one hand according to the plastic of which the film is produced, as well as also according to the characteristics that the film to be produced shall have.

So that the portion of the treatment fluid that is guided or conveyed out of one treatment zone into the process-technically following or subsequent treatment zone ensues decoupled from the passage region of the film in the treatment zones, the treatment fluid is guided or conveyed through a connecting channel from treatment zone to treatment zone. This connecting channel is thus flow-technically separated from the passage region of the film through the treatment zones, so that through this arrangement of the connecting channel it is essentially achieved that a laminar flow in the direction of the throughflow or passage of the film through the treatment zones can be minimized.

Preferably the connecting channel is arranged between two ventilation units or two treatment zones or one ventilation unit and one treatment zone. Further preferably the connecting channel is provided between the treatment zone and the ventilation unit that is preferably arranged thereon.

In the connecting channel, apparatuses can be provided, by means of which the flow of the treatment fluid through the connecting channel is preferably regulatable and/or controllable. Thereby the quantity of treatment fluid that is guided or conveyed from one treatment zone to the process-technically subsequent or following treatment zone is influenced.

Further details and embodiments of the invention are now described in detail in connection with the accompanying drawings under description of a preferred example embodiment. In the drawing it is shown by:

FIG. 1 a furnace as a central part of a film stretching plant of an embodiment according to the prior art;

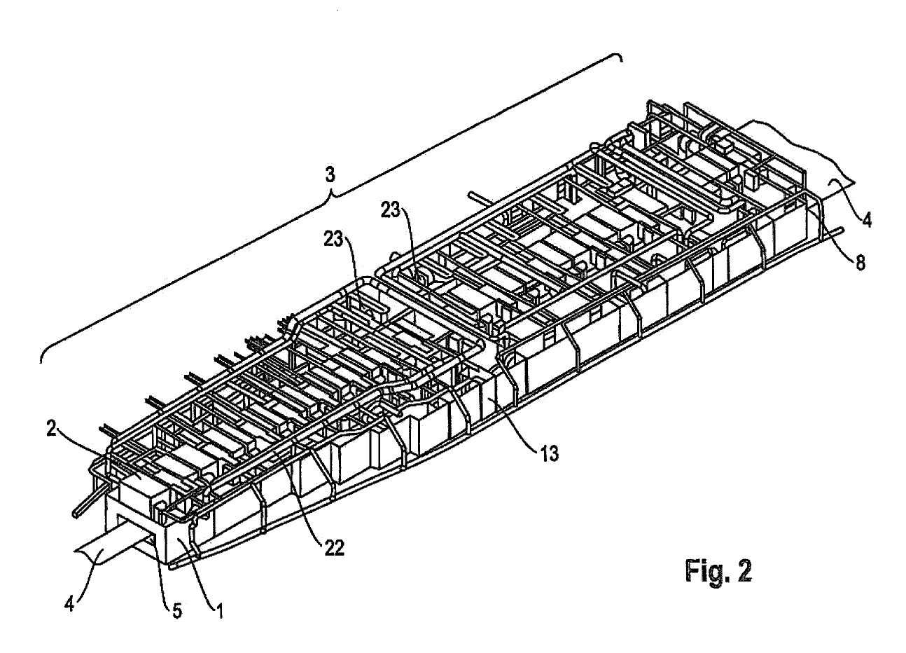

FIG. 2 a three-dimensional view of a plant according to FIG. 1 with illustration of the installed pipelines;

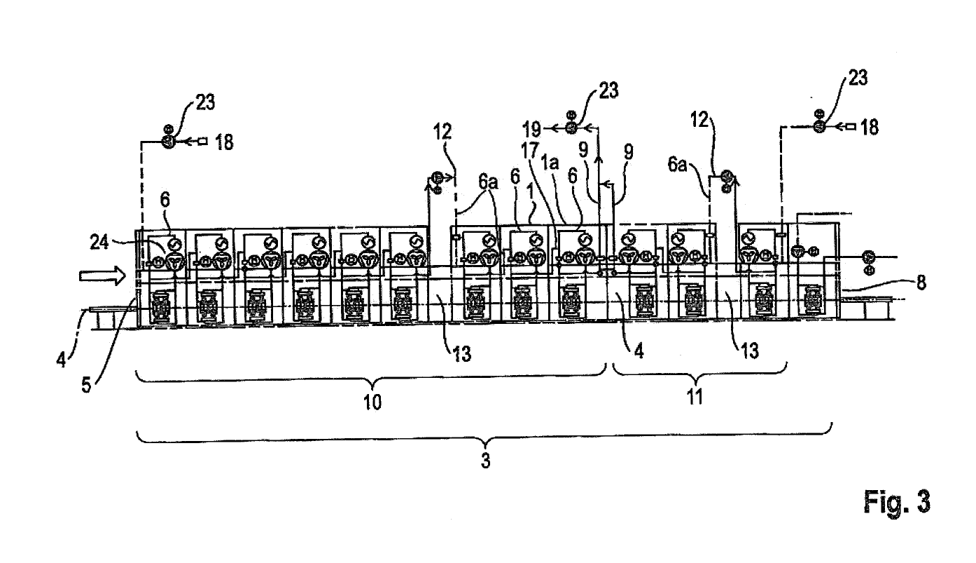

FIG. 3 a principle schematic illustration of the guidance or conveyance of treatment fluid in the furnace of a film stretching plant according to the invention;

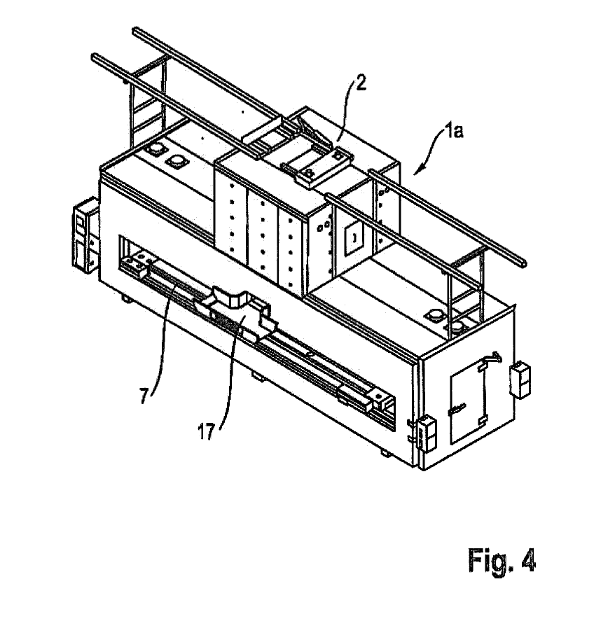

FIG. 4 a treatment zone with a ventilation unit arranged thereon as a partial element of a film stretching plant according to the invention;

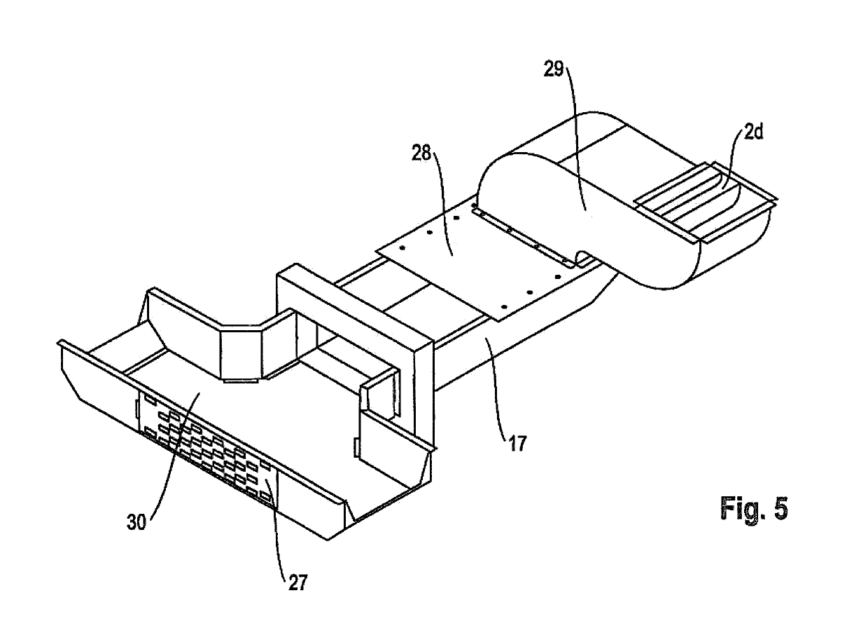

FIG. 5 a connecting channel between adjacent treatment zones for further conveying treatment fluid from one treatment zone to the process-technically adjacent treatment zone;

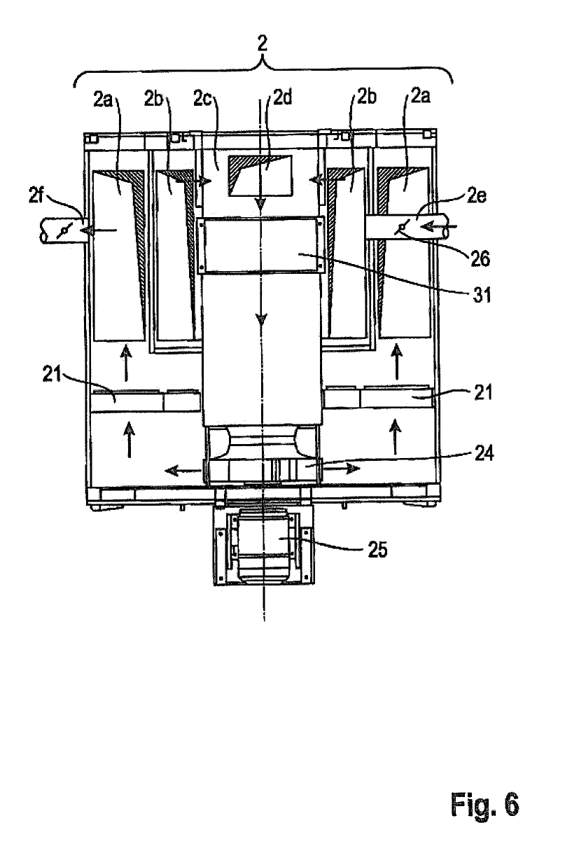

FIG. 6 a principle schematic view of the guidance or conveyance of treatment fluid within a ventilation unit of a treatment zone with indicated additional connecting channel for transferring a portion of the treatment fluid into a ventilation unit of a process-technically following or subsequent treatment zone; and

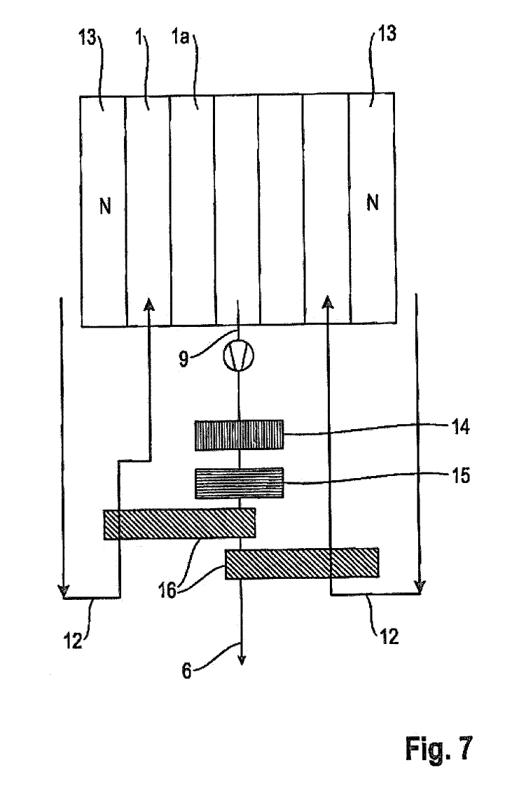

FIG. 7 a principle schematic illustration of a portion of a furnace of a film stretching plant according to the invention with additionally provided catalyzer, a filter unit and a heat recovery device.

In FIG. 1, a furnace is illustrated as a central part of a known film stretching plant. The part that is arranged immediately before the furnace of the film stretching plant is not illustrated here, because the present invention involves essentially the guidance or conveyance of treatment fluid through the furnace that consists of numerous treatment zones.

Before the film enters into the furnace 3 through the film inlet region 5, the plastic material mass, which exists as a raw starting material generally in the form of a granulate, must first be prepared. For that, generally a plastic granulate is supplied from a supply container to a container in the manner of a silo, from which the granulate is supplied to an extruder. In the extruder, which is similarly not illustrated, the plastic is melted and is applied with a correspondingly arranged nozzle onto a cooling roller, which is similarly not illustrated, so that the molten material rigidifies or hardens sufficiently so that a film of a defined width and thickness arises. In an adjoining longitudinal stretching region of the entire film stretching plant, a roller system is provided, of which the process-technically subsequently arranged rollers are driven with a defined higher rotational speed than the rollers that are located process-technically therebefore, so that the film is stretched in the longitudinal direction due to the rotational speed differences.

After the film 4 has entered through the film inlet region into the furnace 3 with its numerous treatment zones, during its treatment the film 4 is thermally treated in various different treatment zones and simultaneously stretched in the width. Thereby the film 4 at the film outlet region 8 of the furnace 3 comprises a significantly larger width than at the film inlet region 5. At the film outlet region 8, the film 4 is thermally treated and stretched into its final state. After a similarly non-illustrated edge trimming, the film is rolled up on a roll in the sense of a goods beam via a roller system that is not illustrated. This non-illustrated roller system is also referred to as a film drawing-off region or film winding region.

The furnace illustrated in FIG. 1 as a central part of the known film stretching plant is divided into numerous treatment zones, of which merely two adjacent treatment zones 1 and 1a are referenced in the manner of an example. Illustrated at the left is the film inlet region 5, and at the right the film inlet region 8. The film 4 is schematically indicated by a long-short-short dashed line at the film inlet region 5 as well as also at the film outlet region 8. Illustrated above all is the treatment fluid guidance or conveyance through numerous pipelines between the individual treatment zones. Neutral zones 13 are arranged between a few treatment zones. Treatment fluid is supplied to and again removed from numerous treatment zones with ventilators 23 arranged outside of the furnace via pipelines arranged outside of the furnace 3 in its longitudinal direction.

This known embodiment avoids, already to a considerable extent, a longitudinal air or longitudinal flow that is detrimental for a uniform temperature profile or for a uniform temperature for the treatment of the film in the individual zones. However, for this known plant, a relatively high energy consumption is necessary, wherein the relatively low longitudinal flow of treatment fluid is attained at the expense of an extensive or voluminous pipeline system.

In this known plant, the film is treated in the respective treatment zones in the through-flow or passage direction of the film through the furnace. However, for ensuring a uniform temperature profile or a high temperature uniformity or a low temperature difference in the individual treatment zones, it is important that the longitudinal flow of treatment fluid through the furnace is controlled. In this known plant, this is already relatively quite well possible due to the extensively constructed pipe system, but the structural effort and therewith the costs for such a plant as well as also the energy consumption for such a plant are high.

For clarifying the great effort and expense of pipelines for this known plant, FIG. 2 shows a three dimensional view from the top onto the known plant according to FIG. 1. Especially clear and recognizable in this known film stretching plant is the extensive pipeline system that is present in the furnace 3 as a central part, wherein this pipeline system is provided for the guidance or conveyance of the treatment fluid which is generally used in the form of air and is exchanged in the treatment zones. The individual treatment zones are interconnected with one another essentially by the illustrated pipeline system. The pipeline system that is shown in FIG. 2 and already indicated in the schematic arrangement in FIG. 1 serves to supply fresh air from the outside into the respective treatment zones, which fresh air must be heated for realizing the respective process-technically required treatment purpose or function in the respective treatment zone. This, however, leads to a high energy consumption of the overall plant.

In the example embodiment according of the invention according to FIG. 3, the exchange of treatment fluid is achieved with distinctly less energy consumption than in the known plants, and simultaneously with very low longitudinal flow of treatment fluid in the film passage region. Thereby a very good temperature profile adapted to the optimal process treatment parameters is ensured in the treatment zones. The smaller energy consumption is primarily based on the fact that the quantity of treatment fluid 6 that is freshly supplied to the entire furnace 3 is significantly reduced in comparison to the prior art according to FIG. 1. According to the invention, this is achieved without an increase of the quantity of the treatment fluid flowing along the film. A treatment fluid 6 that is freshly supplied to the furnace is supplied to the furnace at a location that is favorable with respect to the temperature profile, and is then conveyed further as a partial flow 6a to a process-technically following or subsequent treatment zone in a manner that is targeted, defined and separated from the film passage region. Preferably, the partial flow 6a is conveyed further from a treatment zone 1 to an adjacent treatment zone 1a with a higher process temperature. Thereby the partial flow 6a can always take up additional contaminants without a danger of re-sublimation and condensation. It is thus achieved, that the treatment fluid that is freshly supplied to the entire furnace is optimally utilized.

A furnace as a central part of the film stretching plant according to the invention with the novel guidance or conveyance of treatment fluid is now illustrated in a principle schematic illustration in FIG. 3. Also in this example embodiment according to the invention, the furnace 3 consists of numerous treatment zones, of which once again two successive treatment zones 1 and 1a are referenced. Two neutral zones 13 are arranged in the furnace 3 itself. Treatment fluid 6 is supplied to the first treatment zone of the furnace 3, in which the film inlet region 5 for supplying the film 4 is located. The corresponding ventilation units 2 belonging to each treatment zone are schematically illustrated. In that regard, the term treatment zone is understood to mean the actual treatment zone together with the ventilation unit. The ventilation unit is arranged in the form of a so-called penthouse on the actual treatment zone.

These ventilation units ensure that in principle 100% of the treatment fluid is circulated within a treatment zone, so that the film to be treated is flowed-around on its upper surface and on its lower surface, without giving rise to the laminar flow or longitudinal flow in the transport direction of the film, which is to be avoided in the treatment zone. Each treatment zone is therefore more or less autonomous or independent, which does justice to the realization of its purpose or object of the thermal treatment of the film in this treatment zone.

It is now provided that only a portion 6a of the treatment fluid 6 from a treatment zone 1 with a defined treatment temperature is guided or conveyed into the process-technically following treatment zone 1a of a higher treatment temperature. This portion 6a of the treatment fluid is controllable and/or regulatable with respect to its quantity, so that on the one hand the total throughput of treatment fluid through the furnace in the longitudinal direction can be reduced, and moreover that the further conveyance of the portion 6a of the treatment fluid 6 takes place in the interior of the furnace, that is to say in the interior of the modular treatment regions consisting of treatment zone and ventilation unit. Thereby, overall considerable quantities of external pipelines and therewith invested costs are saved, which moreover are no longer to be provided on the exterior of the furnace region. This also leads to a reduced heat introduction into the building in which the plant is standing, and to a reduction of the demand for electrical energy, because ventilator energy is similarly saved. Moreover, with the solution according to the invention, a clearly improved, more exact temperature guidance or control can be realized, and in comparison with the known solutions enables an operationally secure or reliable as well as targeted feedback of recovered energy into the system.

Treatment zones between which a neutral zone 13 is arranged, are bridged over by external bridgings 12, so that treatment fluid can also be further conveyed or transferred passing over neutral zones 13. A treatment zone that process-technically follows a neutral zone 13 is also regarded as a process-technically following or subsequent treatment zone 1a. Due to the special type of the further conveyance of treatment fluid between the treatment zones, in any event due to the supply of treatment fluid for example in the first treatment zone which comprises the film inlet region 5, a unidirectional or parallel flow region 10 arises in this region of the furnace, relative to the conveying direction of the film through the furnace 3.

In the present example embodiment, treatment fluid is also fed into a treatment zone located in the end region of the furnace 3, so that a counterflow region 11 is formed from there to the end of the parallel flow region. In the area of the meeting or confluence of parallel flow region 10 and counterflow region 11, a removal location 9 for removing treatment fluid 6 is provided, wherein this removal location 9 is unified or formed in common of both of the treatment zones that are arranged adjacent to one another at that location.

In principle it is of course also possible that depending on the profile of requirements, a furnace of a film stretching plant according to the invention comprises only a parallel or unidirectional flow region. Supply 18 of treatment fluid is illustrated by a dashed line, and the removal 19 thereof is illustrated by a solid continuous line.

The film stretching plant with the novel treatment fluid guidance or conveyance on the one hand serves to reduce the energy consumption in the conveyance of large quantities of fresh treatment fluid as well as in the heating of the air that is preferably used as treatment fluid in the treatment zones for the thermal treatment of the film, and on the other hand serves to constantly branch off such a portion of air so that an optimal contaminant removal in the plant is possible. The disadvantageous influence of contaminants evaporated or volatilized out of the film plays at most a subordinate role in the treatment zones in which the temperature profile for the treatment of the film is raised from treatment zone to treatment zone. This is essentially the case in the region of the unidirectional or parallel flow 10. In the rear part of the furnace, in which a counterflow region 11 of the conveyance of the treatment fluid is provided in the present example embodiment according to FIG. 3, the temperature of the treated film is reduced in the direction toward the film outlet region 8, so that after its exit out of the film outlet region 8 it is cooled down sufficiently so that it can be rolled-up without problems. However, in this cooling process of the film there exists the possibility that the contaminants can be deposited on the surface of the film, which would mean a worsening of the quality of the film. Therefore it is necessary to withdraw or extract the treatment fluid preferably in the region of the furnace in which the process-technically highest temperatures exist in the respective treatment zones.

A single treatment zone with the ventilation unit 2 arranged thereon is illustrated in FIG. 4. The slit-like inlet region illustrated on the front face side of this treatment zone 1 is the passage region 7 of the film. According to a first example embodiment, a connecting channel 17 is recognizable, which is located in the upper region of the treatment zone under the ventilation unit 2 and is closed toward the bottom, so that the transferring of a portion 6a of treatment fluid from one treatment zone to the process-technically following or subsequent treatment zone 1a occurs through this connecting channel 17 decoupled from the passage region 7 of the film. Thereby it is possible to supply a desired portion of treatment fluid to a process-technically following treatment zone 1a, without giving rise to the longitudinal flow in the motion direction of the film through a respective treatment zone, which longitudinal flow is to be avoided for treatment-technical reasons, or without causing such a longitudinal flow to be strengthened due to the further conveyance of a portion of treatment fluid to the process-technically following treatment zone.

FIG. 5 shows a connecting channel 17 according to a first example embodiment, which is already illustrated in FIG. 4 as a separate structural element, and which is arranged with its T-piece closed toward the bottom, above the passage region 7 for the film through the treatment zone 1. The connecting channel 17 is essentially rectangular in cross-section and leads from the T-piece located in the treatment zone 1, through a rectangular channel that extends in the throughflow direction of the film and that has a covering in the form of a middle piece 28, into the process-technically following treatment zone 1a. An S-bend 29 leads from the end of the rectangular channel upwardly into the ventilation unit that is not illustrated. The advantage of this connecting channel 17 exists, among other things, in that it is structurally or constructively guided between the actual treatment zone, that is to say above the passage region 7 of the film through this treatment zone, and in the lower region of the ventilation unit. Thereby, no external pipelines are necessary for the further conveyance of a portion 6a of the treatment fluid 6 from one treatment zone 1 to the process-technically adjacent treatment zone 1a.

The S-bend 29 guides or conveys the treatment fluid from a central arrangement of the connecting channel 17 to a lateral arrangement into the ventilation unit, in which region the heat exchanger is located. Preferably additional guide vanes or guide plates are provided in the S-bend 29, in order to optimally guide and direct the flow to the heat exchanger in the ventilation unit. The perforated metal sheet 27 located on the end face of the T-piece 30 of the connecting channel 17 ensures an additional air supply out of the furnace, that is to say out of the treatment zone. This perforated metal sheet is preferably adjustable with respect to the size of the openings, so that the quantity of the treatment fluid supplied via the perforated metal sheet to the connecting channel 17 can be controlled in an adjustable manner.

The guidance or conveyance of the treatment fluid through the ventilation unit 2 is illustrated in a principle or schematic arrangement in FIG. 6. The treatment fluid 6 is conveyed into the outer region of the ventilation unit 2 by a ventilator 24 such as e.g. a radial ventilator driven by a drive motor 25. There it is conveyed through an optionally provided filter 21 and then comes through a first flow region 2a downwardly into the actual treatment zone. There the treatment fluid impinges onto the film (not shown). The treatment fluid is again sucked back into the ventilation unit 2 through a second flow region 2b by means of the ventilator 24. Now the treatment fluid comes into a third flow region 2c before or in front of the heat exchanger 31. The ventilation unit 2 illustrated in FIG. 6 is the one that belongs to the treatment zone 1a. The partial flow 6a of the treatment fluid out of the process-technically previous treatment zone 1 (see FIG. 3) similarly gets into the third flow region 2c through an opening 2d in the ventilation unit above the (not illustrated) connecting channel 17 belonging to the treatment zone. The partial flow 6a of the treatment fluid can, however, also additionally or instead of this be conveyed via the pipe-shaped connecting channel 2e over the flow region 2b into the third flow region 2c. For that purpose, an adjusting slider 26 is arranged in the pipe-shaped connecting channel 2e, via which the quantity of the partial flow 6a is adjustable. The partial flow 6a thus comes into the third flow region 2c either through the connecting channel 17, in which similarly a further adjusting slider (not shown) can be provided, or through the pipe-shaped connecting channel 2e, or through both of those. The treatment fluid out of the treatment zones 1 and 1a, which has now been commingled and mixed, is thus tempered in common together in the heat exchanger 31, and then comes through the ventilator 24 again into the first flow region 2a, whereby the circulation circuit or loop is closed. Before the treatment fluid again flows downwardly into the associated actual treatment zone, if applicable a portion is conveyed through an opening 2f to the next treatment zone or ventilation unit. It is, however, also possible, that this portion was already derived or branched out of the treatment zone. Through this system, the air balance is maintained, which ultimately leads to the minimizing of the longitudinal flow of the treatment fluid which is detrimental for the process, and therewith leads to a very good uniform temperature distribution over the film.

Above all in narrower plants it can possibly, if applicable, be problematic to accommodate, with regard to the required space, the variant of a rectangular connecting channel 17 (see FIG. 5) described according to the first embodiment. In such a case, according to the second embodiment the connecting channel is embodied only as a pipe-shaped connecting channel 2e, 2f between adjacent ventilation units.

However, FIG. 6 illustrates an example embodiment in which both the connecting channel 17 as well as the pipe-shaped connecting channels 2e, 2f are provided. Through these pipe-shaped connecting channels 2e, 2f or the connecting channel 17, a portion 6a of the treatment fluid 6 is conveyed to the heat exchanger 31 of the respective treatment zone 1a. Thereby it is possible to heat up the portion 6a of the treatment fluid from a previous treatment zone to correspond to the temperature profile that is to be realized in the process-technically following treatment zone 1a for the thermal treatment of the film, and to realize a prescribed temperature profile or a temperature rise or temperature progression in this treatment zone in a targeted manner.

And finally FIG. 7 shows a principle or schematic illustration of a circuit arrangement for the further improvement of the efficiency of the film stretching plant with the novel guidance or conveyance of treatment fluid. For that purpose, a removal location 9 for the treatment fluid is provided in the area of the treatment zones in which process-technically the highest temperatures arise, through which removal location 9 the treatment fluid that has been enriched with contaminants is conveyed through a catalyzer 14 by means of a further blower or ventilator that is not referenced. In principle it is possible to convey the entire treatment fluid 6 through the catalyzer. It is, however, also possible to convey only a portion of the treatment fluid through the catalyzer. In the later case, the catalyzer can be dimensioned smaller. Preferably, only a single catalyzer is provided for the entire plant, that is to say for the entire furnace. Of course it is also possible to provide further catalyzers, so that removals can be carried out at several locations out of treatment zones with process-technically high temperatures. A removal is sensible or purposeful everywhere where process-technical temperatures are present at which the treatment fluid contains a significant content of contaminants, which can be combusted in a or the catalyzers 14.

According to the plant schematic illustrated in FIG. 7, a filter 15 is still additionally arranged after the catalyzer 14. For further increasing the energy efficiency of the film stretching plant according to the invention, a heat recovery device 16 in the form of heat exchangers is provided after the filter, which heat exchangers take the relatively high energy of the removed treatment fluid out of the treatment zones of high or highest process temperature, and give it off to treatment fluid that can be transferred or conveyed via bridging devices 12 either in the non-illustrated unidirectional or parallel flow region or in the non-illustrated counterflow region, so that the treatment fluid in the treatment zones, in which the treatment fluid is supplied by means of the bridging apparatus 12 passing over the respective neutral zones 13, is properly suited to the corresponding temperature profile that exists there.

The arrangement of catalyzers makes sense everywhere where the process temperatures lie above 200° C. For example, for polypropylene films, which are primarily utilized for packagings, the maximum temperatures in the region of 165° C. that arise in such a furnace of a film stretching plant are not high enough so that the use of catalyzers would be worthwhile. The use of catalyzers is thus dependent on the type of the film product that is to be produced. Catalyzers and/or filters in connection with heat recovery devices, are, however, recommendable for films of polyester for packagings, polyester as a thick film or as an optical film, as well as also for polyamide films.

In the present novel treatment fluid guidance or conveyance with very few or preferably only a single removal location, with a considerably reduced treatment fluid quantity that is to be sent through the entire plant, it is for example also possible to heat the treatment fluid from for example 165° C. in polypropylene plants to over 200° C., and thereby make it accessible to an effective catalytic treatment. Thereby the exhaust gas load or quantity can be significantly reduced, or a portion of the treatment fluid can be reused. Thereby the additional energy demand for heating up to over 200° C. can be compensated. Then also, the significantly cleaner air can be conveyed to a heat exchanger in a significantly more operationally secure or reliable manner. This heat exchanger then will become soiled or contaminated significantly less often, whereby the cleaning effort for such a plant is also reduced. Moreover an advantage exists in that the catalyzers, with good dimensioning, can absolutely remove up to 95% of the contaminants.

Energy balance calculations for comparing conventional plants with plants according to the invention, and particularly, both with respect to plants without as well as plants with heat recovery, disclose that considerable energy savings can be achieved with the film stretching plant according to the invention with the novel guidance or conveyance of treatment fluid. Thus, 25 to approximately 30% of energy can be saved in a novel system in comparison to a known system with heat recovery. A comparison of the novel system with a known system without heat recovery finally leads to energy savings in the range from 35 to 40%. If in contrast to that, a novel system with heat recovery is compared with a known system without heat recovery, energy savings arise that can absolutely lie in the region of 50%.

A further advantage relating to the structural or construction technology arises above all in that significant quantities of pipelines that would have to be mounted on the outside in the area of the furnace of the film stretching plant can be saved.

### REFERENCE NUMBER LIST

1 treatment zone
1a following or subsequent treatment zone
2 ventilation unit
2a first flow region
2b second flow region
2c third flow region
2d opening
2e pipe-shaped connecting channel
2f pipe-shaped connecting channel
3 furnace of oven
4 film
5 film inlet region
6 treatment fluid
6a portion of the treatment fluid
7 passage region of the film
8 film outlet region
9 removal location
10 parallel or unidirectional flow region
11 counterflow region
12 bridging device
13 neutral zone
14 catalyzer
15 filter
16 heat recovery device
17 connecting channel
18 supply
19 removal
21 filter in ventilation unit
22 pipeline
23 blower/ventilator
24 ventilator
25 drive motor
26 adjusting slider
27 perforated metal sheet
28 middle piece/cover
29 S-bend
30 T-piece
31 heat exchanger

1. Film stretching plant with a furnace (3) consisting of several treatment zones (1) respectively comprising a ventilation unit (2), to which furnace a film (4) is suppliable via a film inlet region (5), wherein the film (4) is thermally treatable zone-wise in the treatment zones (1), and treatment fluid (6) flows over the film (4) on its upper surface and its lower surface in the treatment zones (1), characterized in that
a) the treatment fluid (6) is circulatable in the respective treatment zone (1) by its respective ventilation unit (2) for the thermal treatment of the film (4), and a portion (6a) of the treatment fluid (6) is conveyed from the respective treatment zone (1) to the process-technically following treatment zone (1a),
b) the portion (6a) of the treatment fluid (6) that is conveyed from the treatment zone (1) into the following treatment zone (1a) is conveyed decoupled from the passage region (7) of the film (4) in the treatment zones (1), and
c) the respective treatment zone (1) is equipped with a heat exchanger, by means of which the portion (6a) of the treatment fluid (6) conveyed to it is adaptable to the temperature that is process-technically required in this treatment zone for the thermal treatment of m the film (4).

2. Film stretching plant according to claim 1, characterized in that treatment fluid (6) is conveyable to the furnace (3) in the film inlet region (5) and in a film outlet region (8) in such a manner so that the treatment fluid (6), with regard to its flow direction and the film motion direction, flows from the film inlet region (5) in unidirectional or parallel flow and flows from the film outlet region (8) in counterflow.

3. Film stretching plant according to claim 1, characterized in that the treatment fluid (6) is particularly air, and the portion (6a) thereof that is conveyed to the respective treatment zone (1a) as well as the heat exchanger are regulatable in such a manner so that in the respective treatment zone (1a) a defined temperature profile on the thermally treated film is adjustedly settable.

4. Film stretching plant according to claim 1, characterized in that a removal location (9) for the removal of treatment fluid (6) is provided process-technically after the film inlet region (5).

5. Film stretching plant according to claim 4, characterized in that the removal of treatment fluid (6) occurs through the removal location (9) at at least one treatment zone (1), or the removal occurs through respectively one removal location at two treatment zones (1, 1a) arranged adjacent to one another with treatment temperatures that are higher than those in the remaining treatment zones.

6. Film stretching plant according to claim 5, characterized in that the removed treatment fluid is conveyed through a catalyzer (14) which is arranged externally from the treatment zones (1) and catalytically treats the removed treatment fluid.

7. Film stretching plant according to claim 6, characterized in that a filter (15) for filtering the catalytically treated treatment fluid is allocated to the catalyzer (14) in the throughflow direction after the catalyzer.

8. Film stretching plant according to claim 6, characterized in that a heat recovery device (16) is arranged after the catalyzer (14) in the throughflow direction, wherein the recovered heat energy of the heat recovery device is conveyable again to the furnace (3) and/or from which heat recovery device the treatment fluid (6) is conveyable again to selected treatment zones (1).

9. Film stretching plant according to claim 2, characterized in that treatment fluid (6) is removed out of the treatment zones that are arranged at the end of the unidirectional or parallel flow region (10) and at the end of the counterflow region (11).

10. Film stretching plant according to claim 1, characterized in that a bridging device (12) is arranged for transferring treatment fluid (6) over a treatment-free neutral zone (13) to the process-technically following treatment zone.

11. Film stretching plant according to claim 10, characterized in that the bridging devices (12) are regulatable with respect to the treatment fluid volume flow.

12. Film stretching plant according to claim 1, characterized in that the furnace (3) comprises treatment zones (1) in the form of inlet zone, stretching zones, fixing zones and outlet zone, particularly also heating zones, cooling zones and neutral zones (13).

13. Film stretching plant according to claim 1, characterized in that the portion (6a) of the treatment fluid (6) is conveyed through a connecting channel (2e, 2f; 17) from treatment zone (1) to treatment zone (1a), which is separated flow-technically from the passage region (7) of the film (4) through the treatment zones (1).

14. Film stretching plant according to claim 13, characterized in that the connecting channel (2e, 2f; 17) is arranged between two ventilation units (2) or two treatment zones (1) or one ventilation unit (2) and one treatment zone (1).

15. Film stretching plant according to claim 13, characterized in that the flow of the treatment fluid (6) through the connecting channel (2e, 2f; 17) is regulatable and/or controllable.
